(19) United States
(12) Patent Application Publication
(10) Pub. No.: US 2025/0372285 A1
(43) Pub. Date: Dec. 4, 2025

(54) GROMMET AND WIRE HARNESS

(71) Applicant: Yazaki Corporation, Tokyo (JP)

(72) Inventors: Tetsuo NOHARA, Tochigi (JP); Hiroyuki NISHI, Tochigi (JP)

(73) Assignee: Yazaki Corporation, Tokyo (JP)

(21) Appl. No.: 19/209,944

(22) Filed: May 16, 2025

(30) Foreign Application Priority Data
Jun. 4, 2024 (JP) 2024-090431

(51) Int. Cl. H01B 17/30

(52) U.S. Cl. CPC H01B 17/301

(57) ABSTRACT

A grommet includes a winding portion that protrudes from a first end of a body portion in an axial direction, is formed in two different directions, and winds around and covers a branching portion of a wiring member. The winding portion includes a first winding piece extending in a first extending direction along the outer peripheral surface of the branching portion, a second winding piece extending in a second extending direction opposite to the first extending direction, and a first opening end formed at an end in one of the two directions of the winding portion in a wound state and from which a first wiring member extending from the branching portion is drawn out. The first winding piece has a first cutout portion cut out from a distal end of the first winding piece in the first extending direction to the first opening end.

### CROSS-REFERENCE TO RELATED APPLICATION(S)

The present application claims priority to and incorporates by reference the entire contents of Japanese Patent Application No. 2024-090431 filed in Japan on Jun. 4, 2024.

### BACKGROUND OF THE INVENTION

### 1. Field of the Invention

The present invention relates to a grommet and a wire harness.

### 2. Description of the Related Art

In grommets of the related art, waterproof property of branching portions of wiring members are ensured with an ease of an assembly work (see, for example, Japanese Patent Application Laid-open No. JP 2018-46616 A).

In grommets of the related art, in a case of winding with a tape around a grommet portion, into which a wiring member having a small outer diameter and routed to a branch destination is inserted, including the wiring member, the amount of the grommet portion wound and caught in the wiring member is larger than that with a wiring member having a large outer diameter and routed to a branch destination, which makes the tape-winding work not easy. Thus, there is room for improvement from the viewpoint of reducing the work load.

### SUMMARY OF THE INVENTION

An object of the present invention is to provide a grommet and a wire harness capable of reducing the work load of winding a tape on the grommet assembled to a wiring member.

In order to achieve the above mentioned object, a grommet according to one aspect of the present invention includes a body portion that is fitted into a through hole penetrating an attachment target along an axial direction to block water from entering the through hole, and is capable of inserting a wiring member inside along the axial direction; and a winding portion that protrudes from an end of the body portion on one side in the axial direction, intersects with the axial direction, is formed in two directions different from each other, and wraps around to cover a branching portion of the wiring member, wherein the winding portion includes: a first winding piece extending in a first extending direction from the end of the body portion along an outer peripheral surface of the branching portion; a second winding piece extending in a second extending direction opposite to the first extending direction along an outer peripheral surface of the branching portion from the end of the body portion; a first opening end formed at one end of the winding portion in the two directions in a wound state in which the second winding piece wraps and covers the branching portion along the second extending direction and the first winding piece wraps and covers the branching portion and the second winding piece along the first extending direction, and from which a first wiring member extending from the branching portion in one of the two directions is drawn out; and a second opening end formed at an end of the winding portion in another one of the two directions, the second opening end from which a second wiring member extending from the branching portion in the other one of the two directions is drawn out in the wound state, and the first winding piece includes a first cutout portion cut out from a distal end of the first winding piece in the first extending direction to the first opening end.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a grommet and a wire harness according to an embodiment;

FIG. 2 is a front view of the grommet according to the embodiment;

FIG. 3 is a diagram illustrating a wiring state on a first opening end side of a grommet in which a first wiring member having an outer diameter R1 is placed;

FIG. 4 is a schematic view exemplarily illustrating a tape winding state on the first opening end side of the grommet to which the first wiring member having the outer diameter R1 is assembled;

FIG. 5 is a diagram illustrating a wiring state on the first opening end side of the grommet in which a first wiring member having an outer diameter R3 is placed; and

FIG. 6 is a schematic view exemplarily illustrating a tape winding state on the first opening end side of the grommet to which the first wiring member having the outer diameter R3 is assembled.

### DETAILED DESCRIPTION OF THE PREFERRED EMBODIMENTS

Hereinafter, embodiments of the present invention will be described in detail with reference to the drawings. Note that the invention is not limited by the embodiments. That is, components in the following embodiments include those that can be easily perceived by those skilled in the art or those that are substantially the same, and various omissions, substitutions, and modifications can be made without departing from the gist of the invention.

### EMBODIMENTS

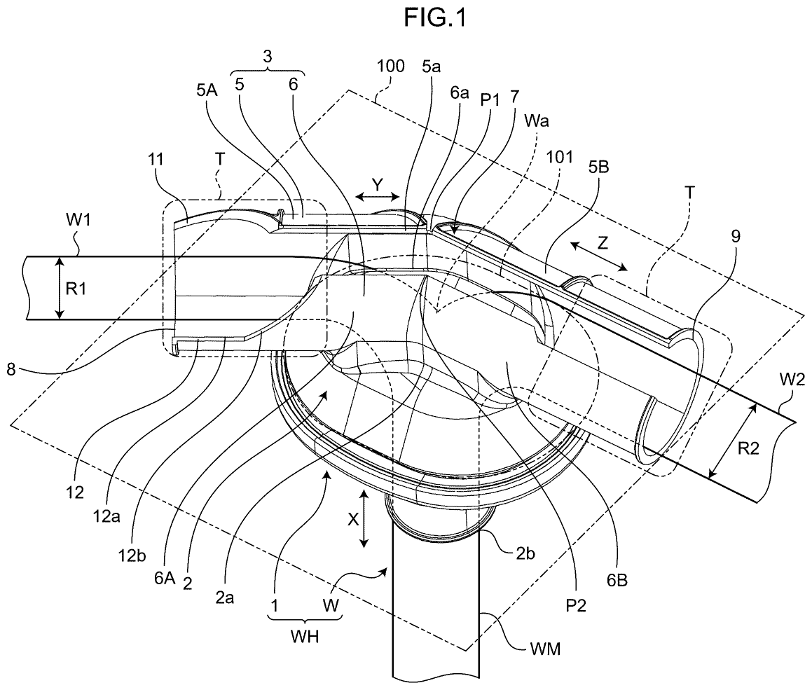

A grommet 1 illustrated in FIG. 1 is incorporated in, for example, a wire harness WH routed in a vehicle or the like and is attached to an attachment panel 100 to be attached and provided on the vehicle side. The attachment panel 100 is, for example, a metal plate included in the body or the like of the vehicle and has a through hole 101. The through hole 101 penetrates the attachment panel 100 in the plate thickness direction. The wire harness WH is, for example, structured in such a manner that a plurality of wiring members W used for power supply or signal communication is bundled to form a collective component for connection between devices mounted on a vehicle and that the plurality of wiring members W is connected to each device by a connector or the like. The wire harness WH includes a wiring member W having conductivity and the grommet 1 provided to the wiring member W and through which the wiring member W is inserted. The wire harness WH may further include various components such as a corrugate tube, a tape member, a vehicle exterior member such as a protector, an electrical connection box, or a fixing tool.

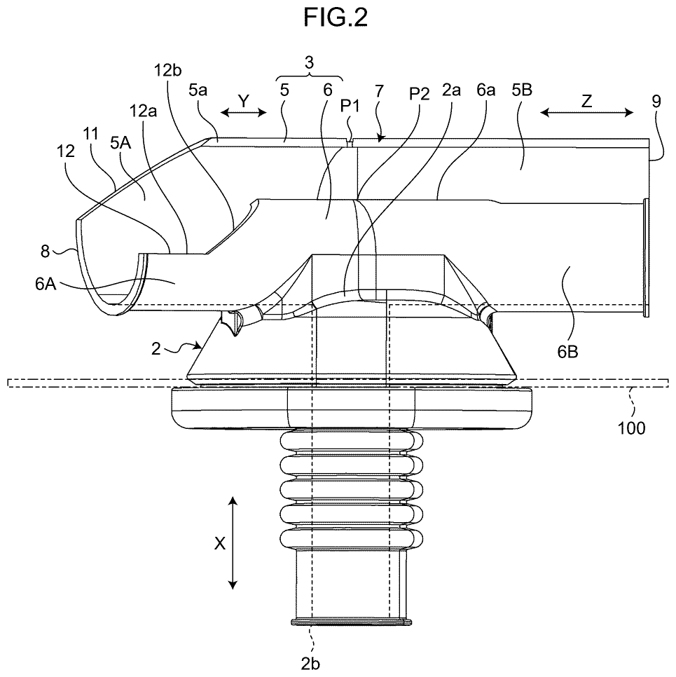

In the following description, for convenience, among the X direction, the Y direction, and the Z direction illustrated in FIGS. 1 and 2, the X direction is defined as an “axial direction X”, the Y direction is defined as a “first branching direction Y”, and the Z direction is defined as a “second branching direction Z”. In the present embodiment, the axial direction X, the first branching direction Y, and the second branching direction Z intersect with each other. The axial direction X corresponds to the plate thickness direction of the attachment panel 100 in the drawing and corresponds to the insertion direction of the wiring member W and the grommet 1 with respect to the through hole 101. It is based on the premise that the first branching direction Y and the second branching direction Z intersect with the axial direction X and are not the same. Each direction used in the following description will be described as that in a state where the grommet 1 is attached to the attachment panel 100 unless otherwise specified.

The wiring member W includes, for example, an electric wire bundle obtained by bundling a plurality of electric wires. In an electric wire, the outer side of a conductive portion (core wire) including a plurality of conductive metal wires is covered with a covering portion having an insulating property. The wiring member W has flexibility as a whole. The wiring member W includes a trunk line WM, a branching portion Wa, a first wiring member W1, and a second wiring member W2.

The trunk line WM is a portion routed in one (the lower side in FIG. 1) of two spaces partitioned with the attachment panel 100 as a boundary. The two spaces partitioned by the attachment panel 100 as a boundary include a vehicle interior space (for example, the cabin) and a vehicle exterior space (for example, the engine compartment). The trunk line WM is drawn out from an opening (not illustrated) provided on one side, in the axial direction X, of the grommet 1 to the vehicle exterior space side of one of the spaces. A portion of the trunk line WM drawn out from the opening is fixed to the grommet 1 by a tape member T (not illustrated) wound around the portion of the trunk line WM together with a part of the grommet 1.

The branching portion Wa is a portion obtained by branching the trunk line WM in two directions of the first branching direction Y and the second branching direction Z and is accommodated inside the grommet 1.

The first wiring member W1 corresponds to a branch line with respect to the trunk line WM, is formed to extend in the first branching direction Y from the branching portion Wa, and is a portion routed on the vehicle interior space side. The first wiring member W1 is drawn out to the outside of the grommet 1 from a first opening end 8 provided on one side in the first branching direction Y of the grommet 1. A portion of the first wiring member W1 drawn out from the first opening end 8 is wound by the tape member T together with a part of the grommet 1 (see FIGS. 1, 4, and 6). That is, in the grommet 1, the first wiring member W1 is fixed to the grommet 1 by the tape member T wound from the first wiring member W1 to the grommet 1 in both sides in the first branching direction Y around the first opening end 8. The first wiring member W1 of the present embodiment has an outer diameter R1. The outer diameter R1 is, for example, relatively smaller than the outer diameter of the trunk line WM.

The second wiring member W2 corresponds to a branch line with respect to the trunk line WM, is formed to extend in the second branching direction Z from the branching portion Wa, and is a portion routed on the vehicle interior space side. The second wiring member W2 is drawn out to the outside of the grommet 1 from a second opening end 9 provided on one side in the second branching direction Z of the grommet 1. A portion of the second wiring member W2 drawn out from the second opening end 9 is wound by the tape member T together with a part of the grommet 1 (see FIG. 1). That is, in the grommet 1, the second wiring member W2 is fixed to the grommet 1 by the tape member T wound from the second wiring member W2 to the grommet 1 in both sides in the second branching direction Z around the second opening end 9. The second wiring member W2 of the present embodiment has an outer diameter R2. It is based on the premise that the outer diameter R2 is, for example, relatively smaller than the outer diameter of the trunk line WM and is relatively larger than the outer diameter R1 of the first wiring member W1 (R2>R1).

The grommet 1 is applied to the through hole 101 of the attachment panel 100 when the wiring member W is routed across the vehicle interior space and the vehicle exterior space with the attachment panel 100 as a boundary. The grommet 1 is attached to the through hole 101 in a state where the wiring member W of the wire harness WH is inserted therein and exteriorly mounted around the wiring member W, thereby protecting the wiring member W passing through the through hole 101 and blocking water from entering (waterproofing) the through hole 101. In addition to waterproofing of the through hole 101, the grommet 1 has functions such as dustproofing and sound insulation between the vehicle interior space and the vehicle exterior space.

As illustrated in FIG. 2, the grommet 1 includes a body portion 2 and a winding portion 3, which are integrally formed as an elastic body. The grommet 1 is formed of, for example, an insulating elastic resin material (For example, ethylene-propylene-diene rubber (EPDM) or the like) having low rigidity and high flexibility, such as rubber or thermoplastic elastomer.

The body portion 2 is a portion that is fitted in the through hole 101 penetrating the attachment panel 100 in the axial direction X to stop water in the through hole 101 and into which the trunk line WM is inserted in the axial direction X. In the body portion 2, the winding portion 3 is formed on a first end 2a side in the axial direction X. The body portion 2 is formed in a substantially tubular shape around the central axis in the axial direction X and has a through hole 2b through which the trunk line WM is inserted. The through hole 2b penetrates from one side to the other side in the axial direction X.

The winding portion 3 is a portion that protrudes from the first end of the body portion 2 in the axial direction X, is formed in two directions that intersect with the axial direction X and are different from each other, and winds and covers the branching portion Wa of the wiring member W. The two directions are, for example, the first branching direction Y and the second branching direction Z. The winding portion 3 includes a first winding piece 5, a second winding piece 6, a slit 7, a first opening end 8, and a second opening end 9.

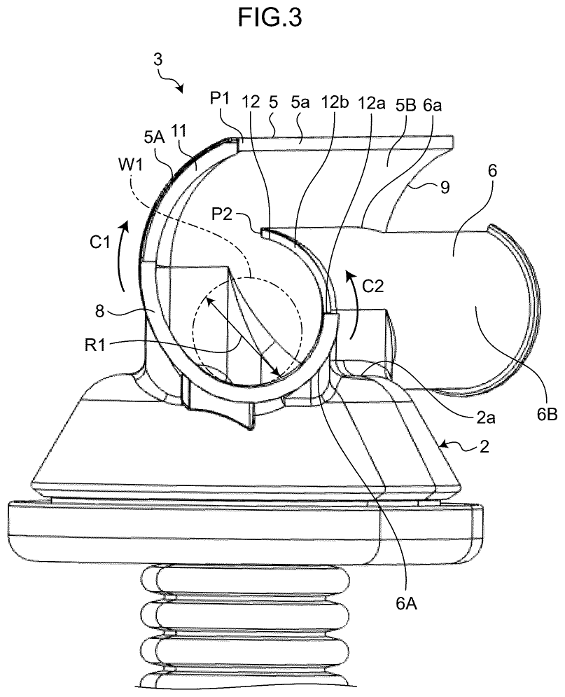

The first winding piece 5 is a portion extending in a first extending direction C1 along an outer peripheral surface of the branching portion Wa of the wiring member W from the end 2a of the body portion 2 (see FIGS. 3 to 6). Since the first branching direction Y and the second branching direction Z intersect with each other, the first winding piece 5 of the present embodiment includes a portion 5A extending from a central portion Pl of the first winding piece 5 in the first branching direction Y and a portion 5B extending in the second branching direction Z, unlike a case where the first branching direction Y and the second branching direction Z are the same direction.

Therefore, in the portion 5A of the first winding piece 5, the first extending direction C1 is, for example, one side in the circumferential direction around the central axis in the first branching direction Y and is a direction from the body portion 2 toward a distal end 5a of the first winding piece 5. Meanwhile, in the portion 5B of the first winding piece 5, the first extending direction C1 is, for example, one side in the circumferential direction around the central axis in the second branching direction z and is a direction from the body portion 2 toward the distal end 5a of the first winding piece 5. The first winding piece 5 is formed integrally with the body portion 2 and the second winding piece 6. In the first winding piece 5, the shape of the portion 5A as viewed from the first branching direction Y is formed in an arc shape, and the shape of the portion 5B as viewed from the second branching direction Z is formed in an arc shape.

As illustrated in FIGS. 1 to 6, the first winding piece 5 of the present embodiment has a first cutout portion 11. The first cutout portion 11 is cut out from the distal end 5a of the first winding piece 5 in the first extending direction C1 to the first opening end 8. The first cutout portion 11 is formed in a substantially linear shape from the distal end 5a toward the first opening end 8; however, it is not limited thereto. In addition, in the first cutout portion 11, it is preferable that the angle formed by the first cutout portion 11 and the distal end 5a exceeds approximately 90 degrees and that the angle formed by the first cutout portion 11 and the first opening end 8 exceeds approximately 90 degrees.

The second winding piece 6 is a portion extending in a second extending direction C2 opposite to the first extending direction C1 along the outer peripheral surface of the branching portion Wa of the wiring member W from the end 2a of the body portion 2 (see FIGS. 3 to 6). Similarly to the first winding piece 5 described above, the second winding piece 6 of the present embodiment includes a portion 6A extending from a central portion P2 of the second winding piece 6 in the first branching direction Y and a portion 6B extending in the second branching direction Z.

Therefore, in the portion 6A of the second winding piece 6, the second extending direction C2 is, for example, the other side in the circumferential direction around the central axis in the first branching direction Y and is a direction from the body portion 2 toward a distal end 6a of the second winding piece 6. Meanwhile, in the portion 6B of the second winding piece 6, the second extending direction C2 is, for example, the other side in the circumferential direction around the central axis in the second branching direction Z and is a direction from the body portion 2 toward the distal end 6a of the second winding piece 6. In the second winding piece 6, the shape of the portion 6A as viewed from the first branching direction Y is formed in an arc shape, and the shape of the portion 6B as viewed from the second branching direction Z is formed in an arc shape.

As illustrated in FIGS. 1 to 6, the second winding piece 6 of the present embodiment has a second cutout portion 12. The second cutout portion 12 is cut out from the distal end 6a of the second winding piece 6 in the second extending direction C2 to the first opening end 8. The second cutout portion 12 is not formed in a substantially linear shape from the distal end 6a toward the first opening end 8; however, it is not limited thereto. The second cutout portion 12 includes a first portion 12a and a second portion 12b. Each of the first portion 12a and the second portion 12b is formed in a substantially linear shape and constitutes a step. The angle formed by the first portion 12a and the first opening end 8 is approximately 90 degrees. The angle formed by the second portion 12b and the distal end 6a exceeds approximately 90 degrees. The second cutout portion 12 of the present embodiment is relatively larger than the first cutout portion 11 described above.

The first winding piece 5 and the second winding piece 6 are continuous with each other at portions protruding from the body portion 2 in the first branching direction Y and the second branching direction Z and have a substantially gutter shape as a whole. The portion 5A of the first winding piece 5 and the portion 6A of the second winding piece 6 protrude in the first branching direction Y, and the portions 5A and 6A are continuous in the circumferential direction of the first wiring member W1 to form a first branching direction Y side of the substantially gutter-shaped portion. The portion 5B of the first winding piece 5 and the portion 6B of the second winding piece 6 protrude in the second branching direction Z side, and the portions 5B and 6B are continuous in the circumferential direction of the second wiring member W2 to form a second branching direction Z side of the substantially gutter-shaped portion. A first end of the substantially gutter-shaped portion where the first winding piece 5 and the second winding piece 6 are continuous with each other forms the first opening end 8, and a second end thereof forms the second opening end 9.

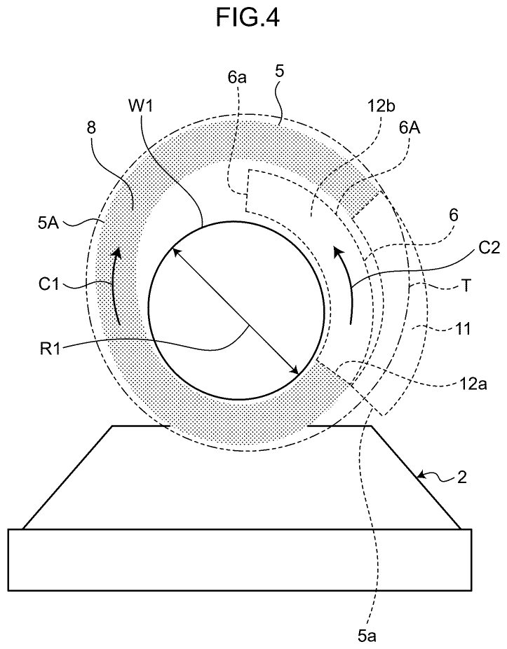

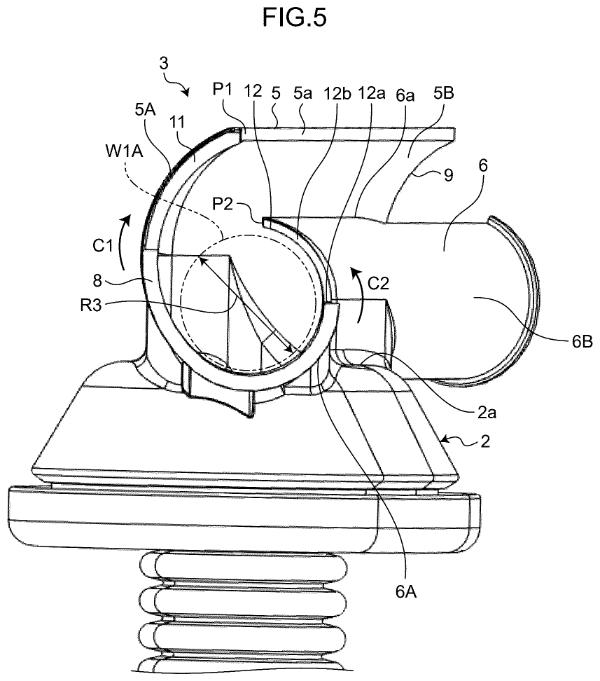

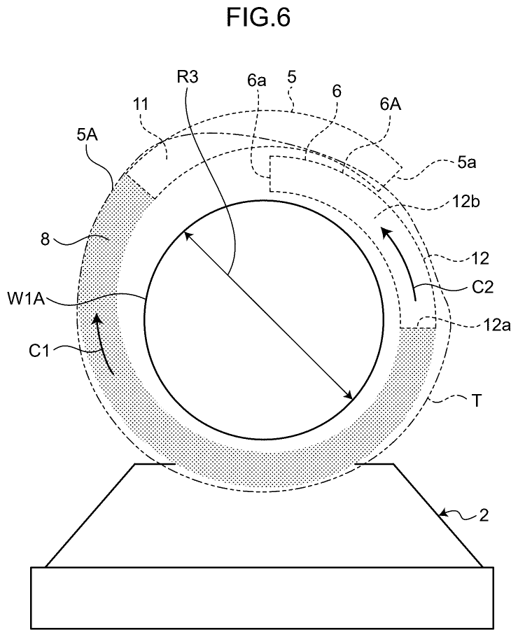

As illustrated in FIGS. 1 and 2, the slit 7 is formed from the first opening end 8 to the second opening end 9 and is positioned between the distal end 5a of the first winding piece 5 and the distal end 6a of the second winding piece 6. The slit 7 is formed to be openable and closable by elastic deformation of each of the first winding piece 5 and the second winding piece 6. For example, as illustrated in FIGS. 2 and 3 (including FIG. 5), the slit 7 is in an open state in a state where the winding portion 3 does not wind and cover the branching portion Wa of the wiring member W, a part of the first wiring member W1, and a part of the second wiring member W2. In other words, in this open state, as described above, the first winding piece 5 and the second winding piece 6 are continuous with each other to form a substantially gutter shape as a whole in the winding portion 3. In the open state, the slit 7 allows the first wiring member W1, the second wiring member W2, and the branching portion Wa in the wiring member W to be routed. On the other hand, for example, as illustrated in FIG. 4 (including FIG. 6), the slit 7 enters a closed state in a wound state in which the second winding piece 6 winds around and covers the branching portion Wa in the second extending direction C2 and the first winding piece 5 winds around and covers the branching portion Wa and the second winding piece 6 in the first extending direction C1. The slit 7 closes the through hole 2b included in the body portion 2 and through which the trunk line WM is inserted in the wound state and the closed state. The distal end 5a on one side included in the slit 7 is positioned to be separated from the distal end 6a on the other side in a state of being separated between one side and the other side in the axial direction X with the slit 7 in the open state.

The first opening end 8 is a portion which is formed at an end in one (the first branching direction Y) of two directions (the first branching direction Y and the second branching direction Z) of the winding portion 3 in the wound state and from which the first wiring member W1 extending in the first branching direction Y, which is one of the two directions, is drawn out from the branching portion Wa of the wiring member W. As illustrated in FIG. 3 (including FIG. 5), the first opening end 8 is formed in a substantially C shape as viewed from the first branching direction Y with the slit 7 in the open state. Meanwhile, as illustrated in FIG. 4 (including FIG. 6), the first opening end 8 is formed in a substantially annular shape as viewed from the first branching direction Y with the slit 7 in the closed state.

The second opening end 9 is a portion which is formed at an end in the other one (second branching direction Z) of the two directions of the winding portion 3 in the wound state and from which the second wiring member W2 extending in the second branching direction Z, which is the other of the two directions, is drawn out from the branching portion Wa of the wiring member W. Although not illustrated, the second opening end 9 is formed in a substantially C shape as viewed from the second branching direction Z with the slit 7 in the open state. Meanwhile, although not illustrated, the second opening end 9 is formed in a substantially annular shape when viewed from the second branching direction Z with the slit 7 in the closed state.

Next, an assembling work of the wire harness WH of the present embodiment will be briefly described. First, after an assembling worker inserts the trunk line WM of the wiring member W into the through hole 2b of the body portion 2, the branching portion Wa of the wiring member W is accommodated in the winding portion 3 via the slit 7 together with a part of the first wiring member W1 and a part of the second wiring member W2. Then, the assembling worker winds around and covers the branching portion Wa with the second winding piece 6 in the second extending direction C2 and then winds around and covers the branching portion Wa and the second winding piece 6 with the first winding piece 5 in the first extending direction C1, thereby causing the wound state. Furthermore, while maintaining the wound state, the assembling worker, for example, winds around the first opening end 8 with the tape member T and then winds around the second opening end 9 with the tape member T.

Disadvantages of the grommets of the related art will be briefly described. For example, in a case where the first wiring member W1 has a relatively small outer diameter, when an assembling worker performs the above-described assembly work, the work load may increase as compared with the first wiring member having a relatively large outer diameter. That is, since the winding amounts of the first winding piece and the second winding piece with respect to the first wiring member having a small outer diameter are relatively large as compared with those of the first wiring member having a large outer diameter, the assembling worker needs to carefully perform the tape winding work while holding the winding portion further firmly so as not to allow a gap to be generated between any pair of the outer peripheral surface of the first wiring member W1, the first winding piece, and the second winding piece, and thus there is a risk of increased mental burden on the work.

Therefore, in the grommet 1 and the wire harness WH of the present embodiment, the first winding piece 5 has the first cutout portion 11 cut out from the distal end of the first winding piece 5 in the first extending direction C1 to the first opening end 8. That is, in the grommet 1 and the wire harness WH, the winding amount of the first winding piece 5 with respect to the first wiring member W1 in the vicinity of the first opening end 8 is relatively reduced due to the first cutout portion 11 as compared with that in a product of the related art. As a result, even in a case where the assembling worker performs the tape winding work while firmly holding the winding portion 3, the degree of caution required is suppressed as compared with that in the case of a product of the related art, and thus the mental burden is reduced.

In addition, in the grommet 1 and the wire harness WH of the present embodiment, the second winding piece 6 has the second cutout portion 12 cut out from the distal end of the second winding piece 6 in the second extending direction C2 to the first opening end 8. That is, in the grommet 1 and the wire harness WH, the winding amount of the second winding piece 6 with respect to the first wiring member W1 in the vicinity of the first opening end 8 is relatively reduced due to the second cutout portion 12 as compared with that in a product of the related art. As a result, even in a case where the assembling worker performs the tape winding work while firmly holding the winding portion 3, the degree of caution required is suppressed as compared with that in the case of a product of the related art, and thus the mental burden is reduced.

As described above, the grommet 1 and the wire harness WH according to the present embodiment include the winding portion 3 that protrudes from the first end of the body portion 2 in the axial direction X, is formed in two different directions, and winds around and covers the branching portion Wa of the wiring member W. The winding portion 3 includes the first winding piece 5 extending in the first extending direction C1 along the outer peripheral surface of the branching portion Wa, the second winding piece 6 extending in the second extending direction C2 opposite to the first extending direction C1, and the first opening end 8 formed at an end in one of the two directions of the winding portion 3 in the wound state and from which the first wiring member W1 extending from the branching portion Wa is drawn out. The first winding piece 5 has the first cutout portion 11 cut out from the distal end of the first winding piece 5 in the first extending direction C1 to the first opening end 8.

In the grommet 1 and the wire harness WH of the present embodiment, the winding amount of the first winding piece 5 with respect to the first wiring member W1 in the vicinity of the first opening end 8 is relatively reduced due to the first cutout portion 11 as compared with that in the related art in which the first cutout portion 11 is not formed. As a result, in the grommet 1 and the wire harness WH, even if the assembling worker performs the tape winding work while firmly holding the winding portion 3, the degree of caution required is suppressed and the mental burden is reduced as compared with those in the case of a product of the related art, and as a result, the work load of the tape winding on the grommet 1 assembled to the wiring member W can be reduced.

In addition, in a grommet of the related art, the first winding piece is made relatively larger than the second winding piece, and the branching portion Wa is wound and covered in such a manner that the through hole 2b through which the trunk line WM is inserted is closed by the first winding piece, thereby ensuring the sound insulation property of the grommet 1 attached to the attachment panel 100. However, in this case, it is necessary that the outer diameter R1 of the first wiring member W1 and the outer diameter R2 of the second wiring member W2 be substantially the same. That is, in the grommet of the related art, for example, in a case where the outer diameter R1 of the first wiring member W1 is relatively smaller than the outer diameter R2 of the second wiring member W2, even if the branching portion Wa is wound and covered by the first winding piece, a gap generated between each pair of the outer peripheral surface of the first wiring member W1, the inner curved surface of the first winding piece 5, and the inner curved surface of the second winding piece 6 is larger than a gap generated between each pair of the outer peripheral surface of the second wiring member W2, the inner curved surface of the first winding piece 5, and the inner curved surface of the second winding piece 6, and thus there is a possibility that the sound insulation property of the grommet 1 cannot be ensured.

Therefore, in the grommet 1 and the wire harness WH of the present embodiment, by including the first cutout portion 11 in the first winding piece 5, the winding amount of the first winding piece 5 with respect to the first wiring member W1 in the vicinity of the first opening end 8 is relatively reduced as compared with that in a product of the related art, and the a gap generated between each pair of the outer peripheral surface of the first wiring member W1, the inner curved surface of the first winding piece 5, and the inner curved surface of the second winding piece 6 can be reduced as a whole. As a result, even in a case where the outer diameter R1 of the first wiring member W1 is relatively small with respect to the outer diameter R2 of the second wiring member W2, the grommet 1 and the wire harness WH can maintain the sound insulation property similarly to the grommets in the related art.

In addition, in the grommet 1 and the wire harness WH, the second winding piece 6 has the second cutout portion 12 cut out from the distal end of the second winding piece 6 in the second extending direction C2 to the first opening end 8. As a result, it is possible to reduce the amount of overlap in the radial direction of the first wiring member W1 between an end 5b of the first winding piece 5 on the first opening end 8 side and an end 6b of the second winding piece 6 on the first opening end 8 side, whereby the workability of tape winding can be further improved.

In addition, in the grommet 1 and the wire harness WH, since the second cutout portion 12 is relatively large with respect to the first cutout portion 11, the above-described effect can be obtained even in a case where the outer diameter R1 of the first wiring member W1 is as small as possible.

In the above embodiment, the first wiring member W1 has been described as having the outer diameter R1 smaller than the outer diameter R2 of the second wiring member; however, it is not limited thereto. FIG. 5 is a diagram illustrating a wiring state on the first opening end side of the grommet in which the first wiring member having the outer diameter R3 is placed. FIG. 6 is a schematic view exemplarily illustrating a tape winding state on the first opening end side of the grommet to which the first wiring member having the outer diameter R3 is assembled.

The outer diameter R3 of the first wiring member W1A illustrated in FIGS. 5 and 6 is relatively larger than the outer diameter R1. The outer diameter R3 is preferably, for example, smaller than the outer diameter of the trunk line WM and substantially equal to the outer diameter R2 of the second wiring member W2. In the grommet 1 and the wire harness WH, since the first winding piece 5 has the first cutout portion 11, the winding amount of the first winding piece 5 with respect to the first wiring member W1A in the vicinity of the first opening end 8 is relatively small as compared with that in a grommet of the related art. Meanwhile, in the first winding piece 5, the portion other than the first cutout portion 11 winds around the first wiring member W1A to cover the branching portion Wa as in the related art, and thus it is possible to reduce the work load of winding the tape on the grommet 1 assembled to the wiring member W and to secure the sound insulation property of the grommet 1.

Note that, in the above embodiment, the first branching direction Y and the second branching direction Z intersect with the axial direction X and are not the same direction; however, it is not limited thereto. For example, the first branching direction Y and the second branching direction Z may be the same direction.

In the above embodiment, the first cutout portion 11 is formed in the first winding piece 5, and the second cutout portion 12 is formed in the second winding piece 6; however, it is not limited thereto. The second cutout portion 12 may not be formed in the second winding piece 6, and the first cutout portion 11 may be formed only in the first winding piece 5.

Furthermore, in the above embodiment, the first cutout portion 11 and the second cutout portion 12 are both formed on the first opening end 8 side; however, it is not limited thereto. The first cutout portion 11 and the second cutout portion 12 may be formed on both the first opening end 8 side and the second opening end 9 side.

According to a grommet and a wire harness according to an aspect of the present embodiment, it is possible to reduce the work load of winding a tape on the grommet assembled to the wiring member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A grommet comprising:
a body portion that is fitted into a through hole penetrating an attachment target along an axial direction to block water from entering the through hole, and is capable of inserting a wiring member inside along the axial direction; and
a winding portion that protrudes from an end of the body portion on one side in the axial direction, intersects with the axial direction, is formed in two directions different from each other, and wraps around to cover a branching portion of the wiring member, wherein
the winding portion includes:
a first winding piece extending in a first extending direction from the end of the body portion along an outer peripheral surface of the branching portion;
a second winding piece extending in a second extending direction opposite to the first extending direction along an outer peripheral surface of the branching portion from the end of the body portion;
a first opening end formed at one end of the winding portion in the two directions in a wound state in which the second winding piece wraps and covers the branching portion along the second extending direction and the first winding piece wraps and covers the branching portion and the second winding piece along the first extending direction, and from which a first wiring member extending from the branching portion in one of the two directions is drawn out; and
a second opening end formed at an end of the winding portion in another one of the two directions, the second opening end from which a second wiring member extending from the branching portion in the other one of the two directions is drawn out in the wound state, and
the first winding piece includes a first cutout portion cut out from a distal end of the first winding piece in the first extending direction to the first opening end.

2. The grommet according to claim 1, wherein
the second winding piece has a second cutout portion cut out from a distal end of the second winding piece in the second extending direction to the first opening end, and
the second cutout portion is relatively large with respect to the first cutout portion.

3. A wire harness comprising:
a wiring member having conductivity; and
a grommet provided to the wiring member, wherein
the grommet includes:
a body portion that is fitted into a through hole penetrating an attachment target along an axial direction to block water from entering the through hole, and is capable of inserting a wiring member inside along the axial direction; and
a winding portion that protrudes from an end of the body portion on one side in the axial direction, intersects with the axial direction, is formed in two directions different from each other, and wraps around to cover a branching portion of the wiring member,
the winding portion includes:
a first winding piece extending in a first extending direction from the end of the body portion along an outer peripheral surface of the branching portion;
a second winding piece extending in a second extending direction opposite to the first extending direction along an outer peripheral surface of the branching portion from the end of the body portion;
a first opening end formed at one end of the winding portion in the two directions in a wound state in which the second winding piece wraps and covers the branching portion along the second extending direction and the first winding piece wraps and covers the branching portion and the second winding piece along the first extending direction, and from which a first wiring member extending from the branching portion in one of the two directions is drawn out; and
a second opening end formed at an end of the winding portion in another one of the two directions, the second opening end from which a second wiring member extending from the branching portion in the other one of the two directions is drawn out in the wound state, and
the first winding piece includes a first cutout portion cut out from a distal end of the first winding piece in the first extending direction to the first opening end.
